(19) United States
(12) Patent Application Publication
(10) Pub. No.: US 2016/0026698 A1
(43) Pub. Date: Jan. 28, 2016

(54) ENABLING BUSINESS PROCESS CONTINUITY ON PERIODICALLY REPLICATED DATA

(71) Applicants: Peter Eberlein, Malsch (DE); Bare Said, St Leon-Rot (DE)

(72) Inventors: Peter Eberlein, Malsch (DE); Bare Said, St Leon-Rot (DE)

(21) Appl. No.: 14/339,048

(22) Filed: Jul. 23, 2014

(51) Int. Cl. G06F 17/30; H04L 29/08

(52) U.S. Cl. CPC G06F 17/30575; H04L 67/28

(57) ABSTRACT

The present disclosure involves systems, software, and computer implemented methods for integrating a source system with a target system. One computer-implemented method includes: starting a process, by operation of computer, the process missing actual data required for the process to complete; creating a proxy data object as a substitute for the actual data to allow the process to execute; executing the process using the proxy data object until the actual data is required for the process to continue execution; replacing the proxy data object with the actual data; and continuing to execute the process with the actual data.

### TECHNICAL FIELD

The present disclosure relates to computer-implemented methods, software, and systems for integrating a source system with a target system.

### BACKGROUND

An application can be implemented using object-oriented programming (OOP) techniques. OOP includes representing entities used in, or otherwise associated with, the application as one or more objects. An object can be defined as a set of data elements and a set of functions, or methods, which can be invoked to perform some action on or related to an instance of the object. An object can include or can otherwise refer to one or more other objects. The application can be configured to create one or more object instances and invoke one or more actions on the one or more object instances.

Cloud computing can be used for the delivery of software functionality as services, as compared to the delivery of software functionality in products. With cloud computing, shared resources, software, and information can be provided to computers and other devices over a network. The use of cloud computing can include the sharing of resources to achieve coherence and economies of scale, in an approach that is similar to one used by utility companies.

### SUMMARY

The present disclosure involves systems, software, and computer implemented methods for integrating a source system with a target system. One computer-implemented method includes: starting a process, by operation of computer, the process missing actual data required for the process to complete; creating a proxy data object as a substitute for the actual data to allow the process to execute; executing the process using the proxy data object until the actual data is required for the process to continue execution; replacing the proxy data object with the actual data; and continuing to execute the process with the actual data.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, wherein the process executes in a cloud-computing environment.

A second aspect, combinable with any of the previous aspects, wherein the proxy object stores information to match against received data to determine if the received data contains the actual data.

A third aspect, combinable with any of the previous aspects, wherein the information to match can be entered by a user when the process is started as new or derived from referencing data objects when the process requires additional data during execution.

A fourth aspect, combinable with any of the previous aspects, wherein the received data is one of a scheduled upload or as a result of an exceptional upload request.

A fifth aspect, combinable with any of the previous aspects, wherein the exceptional upload request is based on one or more rules, the one or more rules based on financial value or time.

A sixth aspect, combinable with any of the previous aspects, comprising determining if the actual data has been replicated during the execution of the process using the proxy data object.

A seventh aspect, combinable with any of the previous aspects, comprising determining whether an exceptional upload request is required to obtain the actual data.

An eighth aspect, combinable with any of the previous aspects, comprising requesting an exceptional upload of the actual data.

A ninth aspect, combinable with any of the previous aspects, comprising waiting until the actual data has been replicated.

A tenth aspect, combinable with any of the previous aspects, wherein the exceptional upload is performed automatically in response to the exceptional upload request.

An eleventh aspect, combinable with any of the previous aspects, wherein the exceptional upload is performed manually in response to the exceptional upload request.

A twelfth aspect, combinable with any of the previous aspects, wherein the scheduled upload or an exceptional upload performed based on the exceptional upload request use a same interface to upload data.

The subject matter described in this specification can be implemented in particular implementations so as to realize one or more of the following advantages. Business processes can be started or continued when data that would typically be required to start or continue a respective business process is missing. The missing data can be transparently inserted into the started/continued process, either through a scheduled or exceptional upload.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a high-level block diagram of an example distributed computing system (EDCS) for integrating a source system with a target system according to an implementation.

FIG. 2 illustrates a system in which data is replicated from an on-premise system to a cloud-based process over time according to an implementation.

FIG. 3 is a flowchart of an example method for integrating a source system with a target system according to an implementation.

FIG. 4 is a sequence diagram illustrating a method for replicating data from a source system to a target system according to an implementation.

FIG. 5 is a block diagram of an exemplary computer used in the EDCS according to an implementation

Like reference numbers and designations in the various drawings indicate like elements.

### DETAILED DESCRIPTION

The following detailed description is presented to enable any person skilled in the art to make, use, and/or practice the disclosed subject matter, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

Cloud computing, as described above, involves the use of shared resources and can include multiple service solutions interacting with one another. Some or all of the multiple service solutions may need to share data with other service solutions. The market for service solutions can be competitive, and service solution providers may desire to put their service offering on the market as soon as possible. A service solution provider may provide a lightweight integration interface (e.g., a periodic batch upload of master data) to share data with other service solutions in order to reduce implementation time of the service provider's service solution, as compared to providing a more complicated integration interface. The lightweight integration interface can be, for example, an upload of a CSV (Comma Separated Values) file or some other type of file.

A downside of a periodic batch update is the latency with which data is replicated. If uploads happen once a week, for example, a new record created in an on-premise backend system might not be available in a cloud solution for up to seven days. Even with daily replication, data might not be available for up to twenty four hours. When relying on a periodic batch update, business processes that need to operate on backend system data cannot be executed (or possibly even started), until replication of the backend system data is performed.

A proxy object can be implemented as a solution to business processes not being able to execute due to waiting for data replication. Use of a proxy object can enable business processes (e.g., business applications) to start execution and to begin processing without having access to missing data. The proxy object can take the place of the missing data so the business process can be started. The proxy object can be replaced with the actual data once the data becomes available. A rule-based callback mechanism can be used to request high-priority data out of schedule.

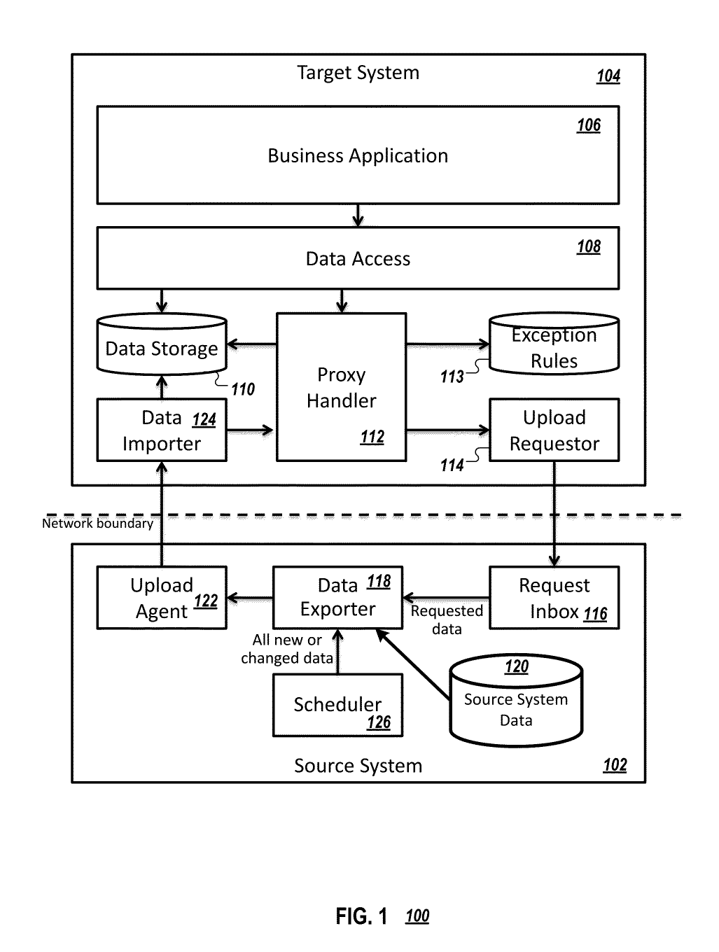

FIG. 1 is a high-level block diagram of an example distributed computing system (EDCS) 100 for integrating a source system 102 with a target system 104 according to an implementation. The following description is presented to enable any person skilled in the art to make and use the invention, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

A business application 106 that executes on the target system 104 includes business logic for processing data that is created and/or managed by the business application 106 in the target system 104 and/or data that is replicated from the source system 102. The business application 106 includes or is otherwise associated with a data access component 108. The data access component 108 provides an abstraction for replicated data to the business application 106. When data is requested by the business application 106, the data access component 108 provides the requested data from a data storage component 110 if the requested data is available in the data storage component 110. Data may be included in the data storage component 110, for example, as a result of a scheduled upload or an exceptional upload. When the requested data is not available in the data storage component 110, the data access component 108 invokes a proxy handler 112 to create a proxy object for the business application 106 to use until the actual data becomes available.

The proxy handler 112 can store the created proxy object in the data storage component 110. When the business application 106 requests access to an area of the proxy object that is not populated with actual data (e.g., is empty or is populated with proxy data), the proxy handler 112 can determine that the business application 106 can't continue processing using just the proxy object and needs actual data for the object represented by the proxy object. The proxy handler 112 can evaluate one or more data type specific exception rules 113 to determine whether to generate an exceptional upload request.

An exception rule specifies a condition under which an exceptional upload can be requested. An exception rule can refer to one or more fields in a proxy object and/or one or more fields in one or more other objects that are related to a proxy object. For instance, an example rule for a business partner object can be “if an order for a business partner proxy object has a total value >100000 then request the business partner object for an exceptional upload”.

When the proxy handler 112 determines that an exceptional upload is not to be requested, the business application 106 can be configured to wait until the data that was attempted to be accessed is available after a next scheduled upload. When the proxy handler 112 determines that an exceptional upload is to be requested, the proxy handler 112 can trigger an upload requestor 114 to send an exceptional upload request to the source system 102. The exceptional upload request can be of various forms. For example, an exceptional upload request can be a web service message, a text message, an email, or some other type of message. The exceptional upload request can include identifying information that specifies which business data is requested for exceptional upload. For example, the identifying information can include a customer name associated with a customer object.

The exceptional upload request can be received at a request inbox 116 included in or otherwise associated with the source system 102. The request inbox 116 can be any entity that can receive exceptional upload requests from the upload requestor 114. For example, the request inbox 116 can be a service (e.g., a web service) that is invoked by the upload requestor 114. As other examples, the request inbox 116 can be a workflow inbox or an email inbox. When the request inbox 116 is a service, an automatic upload can be initiated in response to the exceptional upload request. When the request inbox 116 is a workflow or email inbox, an administrator can respond to the exceptional upload request by manually initiating an upload.

A data exporter 118 can be invoked to export data requested by the exceptional upload request from a source system database 120. The data exporter 118 can be invoked by the request inbox 116 (e.g., when the request inbox 116 is a service) or can be invoked as a result of an action taken by an administrator. An upload agent 122 can transfer the exported data from the source system 102 to the target system 104. The uploaded data can be in any of a variety of formats, such as a CSV format, an XML (eXtensible Markup Language) format, or some other type of format.

A data importer 124 can be configured to receive data sent from the source system 102. The received data can be stored in the data storage component 110. The proxy handler 112 can be notified of the received data and can remove any proxy objects that are associated with the received data from the data storage component 110. The received data can be stored in the data storage component 110 as one or more populated business objects, for example. In some implementations, data from a proxy object is copied to a business object instance before the proxy object is deleted. In some implementations, rather than deleting a proxy object, the proxy object is modified to be an actual instance of a data object (e.g., received data may be copied into the proxy object and the proxy object can be converted into an actual, populated object). The business application 106 can be notified (e.g., by the data access component 108) that the data associated with the requested exceptional upload is available. The business application 106 can continue processing in response to the notification.

The data importer 124 can receive data associated with a scheduled upload as well as data associated with an exceptional upload. For example, a scheduler component 126 in the source system can be configured to periodically (e.g., daily) invoke the data exporter 118 to export new and changed data (and indication(s) of deleted data) from the source system database 120 and to invoke the upload agent 122 to upload the extracted data. The scheduler component 126 can be a batch scheduler, for example. The data exporter 118 can export new and changed data (and indication(s) of deleted data) as compared to a state of the source system database 120 at the time of a last scheduled upload. Data that was uploaded by an exceptional upload that occurred after the last scheduled upload may not be included in the next scheduled upload. The upload agent 122 can use a same upload interface for the scheduled upload as for an exceptional upload.

The data importer 124 can receive data associated with the scheduled upload and can store the received data in the data storage component 110. The proxy handler 112 can remove any proxy objects from the data storage component 110 that are associated with the received data. The business application 106 can be notified of data uploaded as a scheduled or exceptional upload. The business application 106 may have been blocked, for example, until the upload of missing data occurs. The business application 106 can be configured to continue processing upon notification that the scheduled upload has completed.

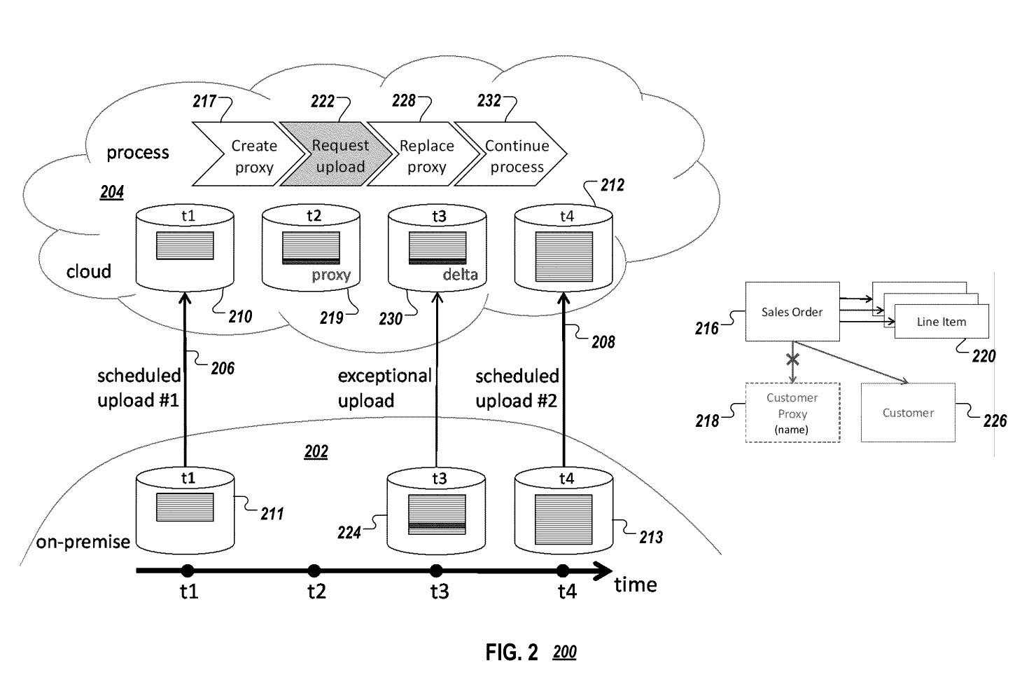

FIG. 2 illustrates a system 200 in which data is replicated from an on-premise system 202 to a cloud-based process 204 over time according to an implementation. Although described as an on-premise system 202, the system 202 can also be a cloud-based system. At time periods t1 and t4, respectively, a first scheduled upload 206 and a second scheduled upload 208 upload new and/or updated data from the on-premise system 202 to the cloud-based process 204. For example, the first scheduled upload 206 and the second scheduled upload 208 can each upload data to a local database used by the cloud-based process 204. For example, a first version 210 of the local database is shown as having been updated by the first scheduled upload 206 to include data in a first version 211 of on-premise data and a second version 212 of the local database is shown as having been updated by the second scheduled upload 208 to include data in a second version 213 of the on-premise data.

The cloud-based process 204 can perform processing that is configured to reference or otherwise use data that is created in the on-premise system 202 at a time point between time points t1 and t4. Such data is not initially available to the cloud-based process 204, since such data was not included in the first scheduled upload 206 and the cloud-based process 204 is configured to use the data before the second scheduled upload 208.

The data to be referenced or used by the cloud-based process 204 can be an object or some other type of data. The object can be directly or indirectly used or referenced by the cloud-based process 204. As an example, the cloud-based process 204 may implement a commerce solution and a sales agent might want to enter an order for a new customer using the cloud-based process 204, but the customer record might not have been replicated from the on-premise system 202. For example, the on-premise system might be used to perform credit checks before new customers are uploaded to the cloud-based process 204.

The sales agent can create an order for the customer by providing a customer name (and possibly other information), but not necessarily a customer identifier and other information associated with the customer. A sales order object 216 can be created to represent the sales order. In a stage 217 of the cloud-based process 204, a proxy object 218 can be created to represent the customer, with the proxy object 218 not including all information for the customer. The proxy object 218 can be associated with the sales order object 216 and stored, for example, in a third version 219 of the local database. Creation of the proxy object 218 enables the cloud-based process 204 to continue processing, even though a fully-populated customer object has not been created for the customer.

For example, the sales agent can initiate other processing, such as the creation of one or more line item objects 220 and the associating of the line item objects 220 with the sales order object 216. Products that are associated with the line item objects 220 can be reserved for the customer, production or procurements requests can be made (e.g., by the cloud-based process 204), and such processing can reference or use the proxy object 218 which represents the customer.

The cloud-based process 204 can perform some processing, as described above, while using or referring to the proxy object 218. However, some processing that the cloud-based process 204 is configured to perform may require customer-related data that is missing from the proxy object 218. For example, payment and/or shipping information may be required before the order associated with the sales order object 216 can be shipped. The cloud-based process 204 can wait, for example, for the second scheduled upload 208 to continue processing related to the sales order 216.

As another example, the cloud-based process 204 can request an exceptional upload of the data that is missing from the proxy object 218, such as illustrated by a stage 222 of the cloud-based process 204. The cloud-based process 204 can request an exceptional upload, for example, in response to evaluation of one or more rules. For example, a rule may specify that an exceptional upload is to be requested when an order total associated with the sales order object 216 is more than a threshold.

In response to the exceptional upload request, the on-premise system 202 can upload, at a time point t3, data included in a third version 224 of the on-premise data, including data that is missing from the proxy object 218, to the cloud-based process 204. The uploaded data can include, among other data, data related to the customer that is included in the third version 224 of the on-premise data but not included in the proxy object 218.

The cloud-based process 204 can create an actual customer object 226 that includes the data from the proxy object 218 and data received from the exceptional upload. As illustrated by a stage 228, the cloud-based process 204 can replace the proxy object 218 with the created customer object 226. The customer object 226 can be associated with the sales order 216 and stored, for example, in a fourth version 230 of the local database. The proxy object 218 can be disassociated with the sales order object 216. In some implementations, the proxy object 218 is modified to include the data received during the exceptional upload, rather than being replaced by the customer object 226.

As illustrated by a stage 232, the cloud-based process 204 can continue processing using the customer object 226. For example, product(s) associated with the sales order represented by the sales order object 216 can be sent to the customer represented by the customer object 226. As another example, a payment from the customer associated with the customer object 226 can be processed. As mentioned above, the cloud-based process 204 can receive updated data from the on-premise system 202, from the second scheduled upload, after stage 232, at the time point t4.

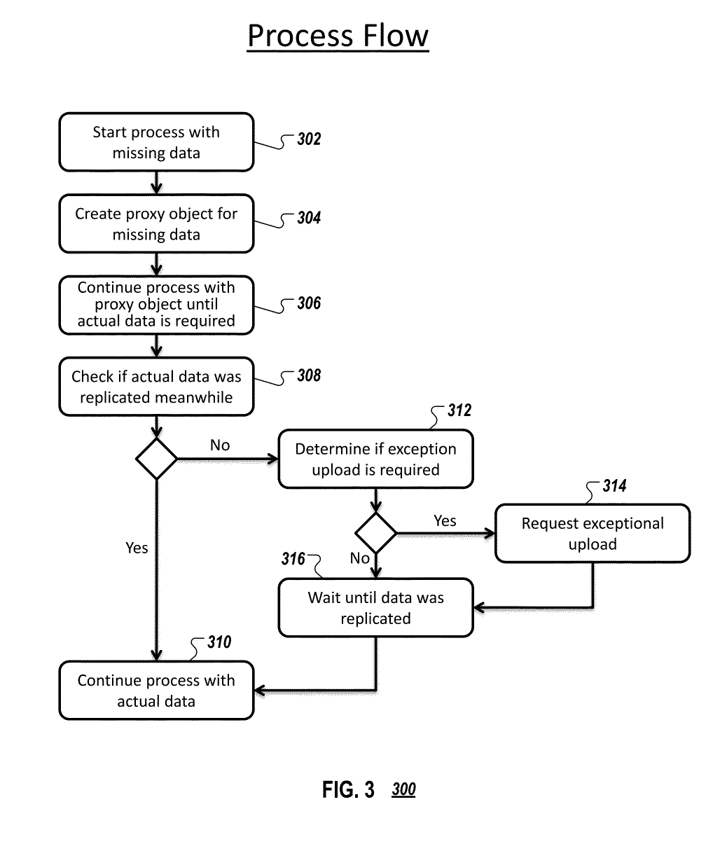

FIG. 3 is a flowchart of an example method 300 for integrating a source system with a target system according to an implementation. It will be understood that method 300 and related methods may be performed, for example, by any suitable system, environment, software, and hardware, or a combination of systems, environments, software, and hardware, as appropriate. For example, one or more of a client, a server, or other computing device can be used to execute method 300 and related methods and obtain any data from the memory of a client, the server, or the other computing device. In some implementations, the method 300 and related methods are executed by one or more components of the EDCS 100 described above with respect to FIG. 1.

At 302, a process is started, by operation of computer, the process missing actual data required for the process to complete. The process can execute, for example, in a cloud-computing environment. As a particular example, the process can be started in a CRM (Customer Relationship Management) system. For example, an order creation process to create an order for a new client can be started. The CRM system can receive data, such as periodically, from an ERP (Enterprise Resource Planning) system. For example, the ERP system can be configured to upload information related to clients and other business entities to the CRM system. A user of the CRM system may, however, desire to perform an action related to a client, such as initiating the order creation process, before data for the client has been received from the ERP system. A CRM user can, for example, start the order creation process and manually enter minimal information for the client, such as a client name and a company address. Other information for the client, such as a shipping address and a billing address, might not yet be available to the CRM system. Such information may be needed, for example, to complete the order creation process, but the information might not be necessary to perform initial processing steps of the process.

At 304, a proxy data object is created as a substitute for the actual data to allow the process to execute. For example, a proxy object representing the new client can be created for use by the order creating process running in the CRM system. The proxy object can include key information such as a client name and a company address for the new client, but may be missing other information, such as a shipping address and an invoicing address. As another example, a client object may refer to or be otherwise associated with multiple, other objects, such as a company address object, a shipping address object, and an invoicing address object. In this example, an actual (e.g., populated) company address object can be associated with the client object and a proxy shipping address object and a proxy invoicing address object can be associated with the client object.

At 306, the process is executed using the proxy data object until the actual data is required for the process to continue execution. For instance, in the example of the order creation process, the order creation process can begin processing related to the order, such as the creation of a production order, the sourcing of goods, the creation of pick lists, etc. In other words, some of the order creation process can be completed using either a proxy client object or a client object that refers to one or more proxy objects. The order creation process can continue until the order creation process reaches a point where missing data is needed. For example, a shipping sub-process might need an actual shipping address. As another example, an invoicing sub-process might need an actual invoicing address.

At 308, a determination is made as to whether actual data has been replicated after the process started and before the actual data is required for the process to continue execution. For example, when no data has been replicated since the process started, a determination can be made that the actual data has not been replicated. When data has been replicated since the process started, a determination can be made as to whether the received data includes the actual data needed by the process. For example, the proxy object can store information (e.g., key information) to match against received data to determine if the received data contains the actual data.

In the example of the order creation process, a determination can be made as to whether data needed by the order creation process has been replicated by the time that the data is needed. For example, the portions of the order creation process that were able to be performed using one or more proxy objects may take some amount of time to complete (e.g., the sourcing of goods, the creation of a production order, the creation of pick lists, etc., may take some time). The order creation process can be configured to determine, for example, whether a shipping address has been replicated to the CRM system by the time the shipping sub-process is invoked, or to determine whether an invoicing address has been replicated by the time the invoicing sub-process is invoked.

When the actual data has been replicated, the proxy data object is replaced, at 310, with the actual data and the process execution is continued with the actual data. For example, a proxy shipping address can be replaced with a replicated (e.g., actual) shipping address and the shipping sub-process of the order creation process can continue. As another example, a proxy invoicing address can be replaced with a replicated (e.g., actual) invoicing address and the invoicing sub-process of the order creation process can continue.

When the actual data has not been replicated, at 312, a determination is made as to whether an exceptional upload is required. For example, one or more rules can be evaluated. A rule can be specific to one or more business object types, for example. A rule can be based, for example, on financial value or other business-value considerations. For instance, a rule can specify to perform an exceptional upload when a total value associated with a sales order is more than a threshold. As another example, a rule can specify to perform an exceptional upload when a customer associated with a sales order is associated with a priority level that is at or above a threshold (e.g., the threshold may be associated with “gold-level” customers). A rule can be based on other criteria, such as time. For example, the rule can specify that the order creation process should not be delayed more than one business day. As another example, a rule can specify that the missing data should be made available to the process a predefined number of days (e.g., five) before a target delivery date.

Evaluation of a rule can include comparing one or more criteria in a rule to a regular upload schedule, to determine, for example, whether a regularly scheduled upload is satisfactory for providing the actual data. For example, evaluation of the rule that specifies that the order creation process should not be delayed more than one business day can include determining that a next scheduled upload will occur two days from the current date. In this example, a determination can be made that the next scheduled upload is not satisfactory and that an exceptional upload should be requested (the exceptional upload can be requested immediately, for example).

When an exceptional upload is required, an exceptional upload is requested, at 314. For example, an automatic message can be sent to a service or system which is configured to provide the missing data. For instance, in the example of the order creation process, the CRM system can send a message to the ERP system to upload data for the new client. The exceptional upload request can be received and processed automatically, as in the case of the automatic message, or the exceptional upload request can be processed manually. For example, the exceptional upload request can be a workflow or email message that is read and processed manually by an administrator. When the data that is requested by the exceptional upload is available, the exceptional upload request can be processed (e.g., either manually or automatically) to upload the requested data.

When the data that is requested by the exceptional upload is not available, the process can be notified as such. The process can be blocked, for example, until the requested data is available and uploaded (e.g., the data can be uploaded automatically once it is available). As another example, the process can be configured to re-request the exceptional upload at a later time (e.g., a time that is after the first exceptional upload request but before the next regularly scheduled upload). As yet another example, the process can be configured to wait until the next scheduled upload

When an exceptional upload is not required, the process waits (e.g., at 316), until the data is replicated. For example, the process can be configured to not request an exceptional upload and can be blocked until a next scheduled upload completes. In some implementations, the process is stopped and is configured to be restarted when the next scheduled upload completes.

When the data is replicated, the process execution is continued with the actual data (e.g., at 310). For example, the process can be notified that uploaded data (either from an exceptional or a scheduled upload) is available. Any proxy object(s) that were created to represent missing data can be deleted and replaced with object(s) that include the actual data. In some implementations, a proxy object is modified to include the missing data rather than deleted. When the process had been stopped (e.g., rather than blocked), the process can be restarted and execution of the process can continue using the actual data.

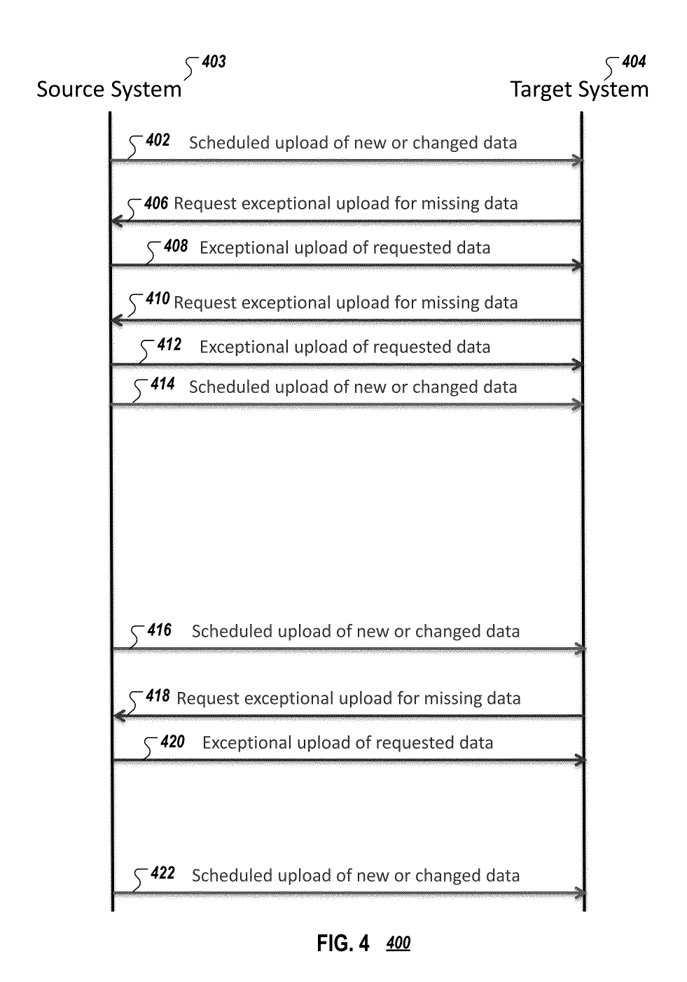

FIG. 4 is a sequence diagram illustrating a method 400 for replicating data from a source system to a target system according to an implementation. For clarity of presentation, the description that follows generally describes method 400 in the context of FIGS. 1-3. However, it will be understood that method 400 may be performed, for example, by any other suitable system, environment, software, and hardware, or a combination of systems, environments, software, and hardware as appropriate. In some implementations, various steps of method 400 can be run in parallel, in combination, in loops, or in any order.

At 402, a source system 403 uploads a first scheduled upload of new and/or changed data to a target system 404. From 402, method 400 proceeds to 406.

At 406, the target system 404 requests an exceptional upload for a first set of missing data. From 406, method 400 proceeds to 408.

At 408, the source system 403 provides the first set of missing data to the target system 404 in a first exceptional upload. From 408, method 400 proceeds to 410.

At 410, the target system 404 requests an exceptional upload for a second set of missing data. The request for the exceptional upload for the second set of missing data illustrates that more than one exceptional upload can be requested between scheduled uploads. From 410, method 400 proceeds to 412.

At 412, the source system 403 provides the second set of missing data to the target system 404 in a second exceptional upload. From 412, method 400 proceeds to 414.

At 414, the source system 403 uploads a second scheduled upload of new and/or changed data to the target system 404. From 414, method 400 proceeds to 416.

At 416, the source system 403 uploads a third scheduled upload of new and/or changed data to the target system 404. The third scheduled upload illustrates that two scheduled uploads can occur with no exceptional upload requests occurring between the two scheduled uploads. From 416, method 400 proceeds to 418.

At 418, the target system 404 requests an exceptional upload for a third set of missing data. From 418, method 400 proceeds to 420.

At 420, the source system 403 provides the third set of missing data to the target system 404 in a third exceptional upload. From 420, method 400 proceeds to 422.

At 422, the source system 403 uploads a fourth scheduled upload of new and/or changed data to the target system 404. From 422, method 400 stops.

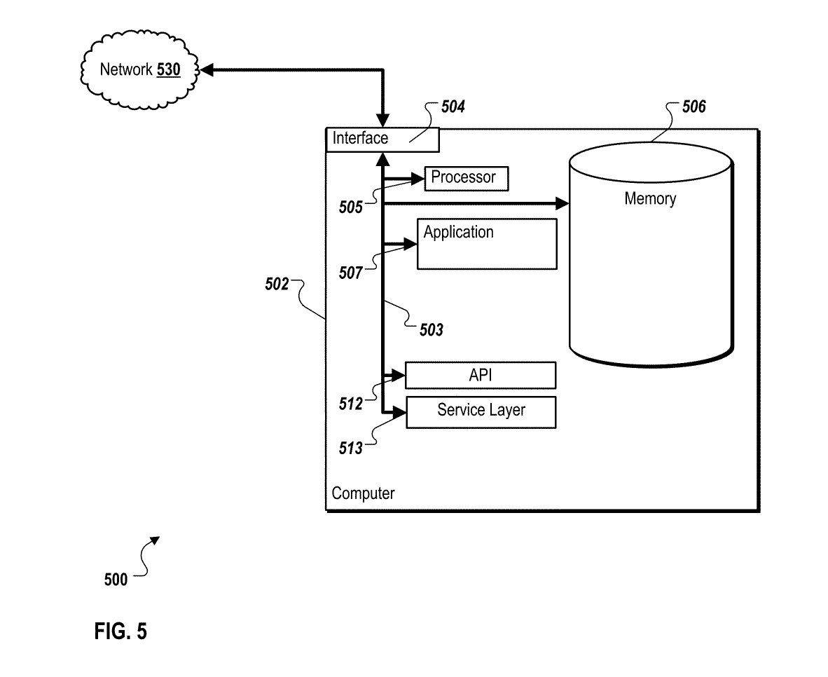

FIG. 5 is a block diagram 500 of an exemplary computer 502 used in the EDCS 100 according to an implementation. The illustrated computer 502 is intended to encompass any computing device such as a server, desktop computer, laptop/notebook computer, wireless data port, smart phone, personal data assistant (PDA), tablet computing device, one or more processors within these devices, or any other suitable processing device, including both physical and/or virtual instances of the computing device. Additionally, the computer 502 may comprise a computer that includes an input device, such as a keypad, keyboard, touch screen, or other device that can accept user information, and an output device that conveys information associated with the operation of the computer 502, including digital data, visual and/or audio information, or a GUI.

The computer 502 can serve as a client, for example client 102 and/or a server, for example executing the source system 102 and/or the target system 104 in a cloud-based computing environment. The computer 502 can also serve as a computer for a database or other persistency (e.g., the data storage component 110, the source system database 120 and/or any other component of the EDCS 100). The illustrated computer 502 is communicably coupled with a network 530. In some implementations, one or more components of the computer 502 may be configured to operate within a cloud-computing-based environment.

At a high level, the computer 502 is an electronic computing device operable to receive, transmit, process, store, or manage data and information associated with the EDCS 100. According to some implementations, the computer 502 may also include or be communicably coupled with an application server, e-mail server, web server, caching server, streaming data server, business intelligence (BI) server, and/or other server.

The computer 502 can receive requests over network 530 from a client application (e.g., executing on another computer 502) and responding to the received requests by processing the said requests in an appropriate software application. In addition, requests may also be sent to the computer 502 from internal users (e.g., from a command console or by other appropriate access method), external or third-parties, other automated applications, as well as any other appropriate entities, individuals, systems, or computers.

Each of the components of the computer 502 can communicate using a system bus 503. In some implementations, any and/or all the components of the computer 502, both hardware and/or software, may interface with each other and/or the interface 504 over the system bus 503 using an application programming interface (API) 512 and/or a service layer 513. The API 512 may include specifications for routines, data structures, and object classes. The API 512 may be either computer-language independent or dependent and refer to a complete interface, a single function, or even a set of APIs. The service layer 513 provides software services to the computer 502 and/or the EDCS 100. The functionality of the computer 502 may be accessible for all service consumers using this service layer. Software services, such as those provided by the service layer 513, provide reusable, defined business functionalities through a defined interface. For example, the interface may be software written in JAVA, C++, or other suitable language providing data in extensible markup language (XML) format or other suitable format. While illustrated as an integrated component of the computer 502, alternative implementations may illustrate the API 512 and/or the service layer 513 as stand-alone components in relation to other components of the computer 502 and/or EDCS 100. Moreover, any or all parts of the API 512 and/or the service layer 513 may be implemented as child or sub-modules of another software module, enterprise application, or hardware module without departing from the scope of this disclosure.

The computer 502 includes an interface 504. Although illustrated as a single interface 504 in FIG. 5, two or more interfaces 504 may be used according to particular needs, desires, or particular implementations of the computer 502 and/or EDCS 100. The interface 504 is used by the computer 502 for communicating with other systems in a distributed environment—including within the EDCS 100—connected to the network 530 (whether illustrated or not). Generally, the interface 504 comprises logic encoded in software and/or hardware in a suitable combination and operable to communicate with the network 530. More specifically, the interface 504 may comprise software supporting one or more communication protocols associated with communications such that the network 530 or interface's hardware is operable to communicate physical signals within and outside of the illustrated EDCS 100.

The computer 502 includes a processor 505. Although illustrated as a single processor 505 in FIG. 5, two or more processors may be used according to particular needs, desires, or particular implementations of the computer 502 and/or the EDCS 100. Generally, the processor 505 executes instructions and manipulates data to perform the operations of the computer 502. Specifically, the processor 505 executes the functionality required to provide integration between a source system and a target system.

The computer 502 also includes a memory 506 that holds data for the computer 502 and/or other components of the EDCS 100. Although illustrated as a single memory 506 in FIG. 5, two or more memories may be used according to particular needs, desires, or particular implementations of the computer 502 and/or the EDCS 100. While memory 506 is illustrated as an integral component of the computer 502, in alternative implementations, memory 506 can be external to the computer 502 and/or the EDCS 100.

The application 507 is an algorithmic software engine providing functionality according to particular needs, desires, or particular implementations of the computer 502 and/or the EDCS 100, particularly with respect to functionality required to provide integration between a source system and a target system. For example, application 507 can serve as the business application 106, the proxy handler 112, the upload requestor 114, the request inbox 116, the data exporter 118, the upload agent 122, the scheduler 126, and/or other application associated with the computer 502 and/or the EDCS 100. Further, although illustrated as a single application 507, the application 507 may be implemented as multiple applications 507 on the computer 502. In addition, although illustrated as integral to the computer 502, in alternative implementations, the application 507 can be external to the computer 502 and/or the EDCS 100.

There may be any number of computers 502 associated with, or external to, the EDCS 100 and communicating over network 530. Further, the term “client,” “user,” and other appropriate terminology may be used interchangeably as appropriate without departing from the scope of this disclosure. Moreover, this disclosure contemplates that many users may use one computer 502, or that one user may use multiple computers 502.

The preceding figures and accompanying description illustrate example processes and computer-implementable techniques. But EDCS 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
starting a process, by operation of computer, the process missing actual data required for the process to complete;
creating a proxy data object as a substitute for the actual data to allow the process to execute;
executing the process using the proxy data object until the actual data is required for the process to continue execution;
replacing the proxy data object with the actual data; and
continuing to execute the process with the actual data.

2. The method of claim 1, wherein the process executes in a cloud-computing environment.

3. The method of claim 1, wherein the proxy object stores information to match against received data to determine if the received data contains the actual data.

4. The method of claim 3, wherein the information to match can be entered by a user when the process is started as new or derived from referencing data objects when the process requires additional data during execution.

5. The method of claim 3, wherein the received data is one of a scheduled upload or as a result of an exceptional upload request.

6. The method of claim 5, wherein the exceptional upload request is based on one or more rules, the one or more rules based on financial value or time.

7. The method of claim 1, comprising determining if the actual data has been replicated during the execution of the process using the proxy data object.

8. The method of claim 1, comprising determining whether an exceptional upload request is required to obtain the actual data.

9. The method of claim 8, comprising requesting an exceptional upload of the actual data.

10. The method of claim 8, comprising waiting until the actual data has been replicated.

11. The method of claim 9, wherein the exceptional upload is performed automatically in response to the exceptional upload request.

12. The method of claim 9, wherein the exceptional upload is performed manually in response to the exceptional upload request.

13. The method of claim 5, wherein the scheduled upload or an exceptional upload performed based on the exceptional upload request use a same interface to upload data.

14. A non-transitory, computer-readable medium storing computer-readable instructions executable by a computer and configured to:
start a process, by operation of computer, the process missing actual data required for the process to complete;
create a proxy data object as a substitute for the actual data to allow the process to execute;
execute the process using the proxy data object until the actual data is required for the process to continue execution;
replace the proxy data object with the actual data; and
continue to execute the process with the actual data.

15. The medium of claim 14, wherein the received data is one of a scheduled upload or as a result of an exceptional upload request.

16. The medium of claim 14, wherein the scheduled upload or an exceptional upload performed based on the exceptional upload request use a same interface to upload data.

17. The medium of claim 14, wherein the process executes in a cloud-computing environment.

18. A computer system, comprising:
a memory;
at least one hardware processor interoperably coupled with the memory and configured to:
start a process, by operation of computer, the process missing actual data required for the process to complete;
create a proxy data object as a substitute for the actual data to allow the process to execute;
execute the process using the proxy data object until the actual data is required for the process to continue execution;
replace the proxy data object with the actual data; and
continue to execute the process with the actual data.

19. The system of claim 18, wherein the received data is one of a scheduled upload or as a result of an exceptional upload request.

20. The system of claim 19, wherein the scheduled upload or an exceptional upload performed based on the exceptional upload request use a same interface to upload data.
